(19) United States
(12) Patent Application Publication
(10) Pub. No.: US 2011/0158399 A1
(43) Pub. Date: Jun. 30, 2011

(54) HEADSET INTERFACE CIRCUIT AND TELEPHONE SET

(76) Inventors: Takeshi Horiuchi, Hachioji-shi (JP); Tomozo Murayama, Hachioji-shi (JP)

(21) Appl. No.: 12/970,779

(22) Filed: Dec. 16, 2010

(30) Foreign Application Priority Data
Dec. 25, 2009 (JP) 2009-296325

(51) Int. Cl. H04M 11/00

(52) U.S. Cl. 379/420.04

(57) ABSTRACT

According to one embodiment, a headset interface circuit includes a connector, a plurality of amplifiers, a detector and an amplification switch. The connector selectively connects a plurality of headsets to a communication apparatus configured to operate at a predetermined power supply voltage and designed to provide telephone calls via a handset. The plurality of amplifiers selectively amplify an output signal from a transmitter of the headset and supply the communications apparatus with the amplified output signal. The detector cause a comparator to detect an operation current of the transmitter of the headset, wherein the comparator operating at a voltage of equal to or smaller than the power supply voltage. The amplification switch switches the amplifier based on a detection result by the detector.

### CROSS-REFERENCE TO RELATED APPLICATIONS

This application is based upon and claims the benefit of priority from Japanese Patent Application No. 2009-296325, filed Dec. 25, 2009; the entire contents of which are incorporated herein by reference.

### FIELD

Embodiments described herein relate generally to a headset interface circuit designed to connect a headset used for communication apparatuses, such as telephone sets, and a telephone set.

### BACKGROUND

A telephone set that provides audio calls (transmission calls and reception calls) allows the calls to be made by connecting a headset formed of a headphone or an earphone and a microphone attached thereto and hands-free calls, as well as via a handset.

Headsets come in various types according to the sensitivity of the transceiver, the operation current, and the like. In order to use such different types of headsets, a plurality of different headset interface circuits needs to be provided and used by switching from one to another, or a headset interface circuit including a switching switch needs to be configured such that switching is made by the switching switch.

Conventionally, a headset interface circuit configured to detect the operation current of the transmitter of the headset and switch the amplification degree of the transmitter according to the detected operation current has also been proposed (see Jpn. Pat. Appln. KOKAI Publication No. 2001-237946).

Since the above-described headset interface circuit is configured so as to perform a thyristor operation using two transistors, an operation voltage of approximately 5 [V] will be required. With the spread of Internet Protocol (IP) telephones in recent years, the power supply voltage requires only 3.3 [V], keeping with trend of lower power consumption. Under the circumstances, a headset interface circuit has strongly been desired that requires an operation voltage of equal to or less than 3.3 [V].

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is a block diagram illustrating the first embodiment of a telephone set;

FIG. 2 illustrates a detailed circuit configuration of a headset interface circuit shown in FIG. 1;

FIG. 3 illustrates voltages and current characteristics (hysteresis characteristics) of a current detection circuit according to the first embodiment;

FIG. 4 illustrates a detailed circuit configuration of a headset interface circuit according to the second embodiment; and

FIG. 5 is a flowchart illustrating the control processing procedure of a control module according to the third embodiment.

### DETAILED DESCRIPTION

Various embodiments will be described hereinafter with reference to the accompanying drawings, in general, according to one embodiment, a headset interface circuit, comprising: a connector configured to selectively connect a plurality of headsets to a communication apparatus configured to operate at a predetermined power supply voltage and designed to provide telephone calls via a handset, wherein the plurality of headsets being different types from one another; a plurality of amplifiers configured to selectively amplify an output signal from a transmitter of the headset and supply the communications apparatus with the amplified output signal, wherein the plurality of amplifiers including different amplification degrees; a detector configured to cause a comparator to detect an operation current of the transmitter of the headset, wherein the comparator operating at a voltage of equal to or smaller than the power supply voltage; and an amplification switch configured to switch the amplifier based on a detection result by the detector.

### First Embodiment

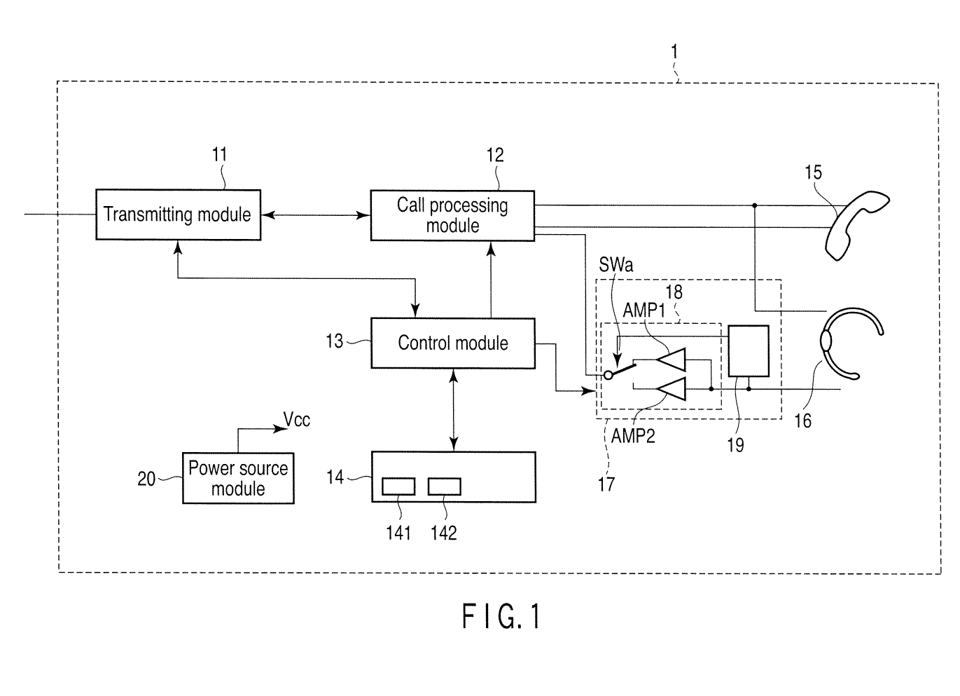

FIG. 1 is a circuit configuration illustrating an embodiment of a telephone set.

In FIG. 1, the reference numeral 1 indicates a telephone set, and includes a transmitting module 11, a call processing module 12, a control module 13, an operation panel module 14, a handset 15, a headset 16, and a headset interface circuit 17.

The transmitting module 11 transmits and receives a variety of data to and from an external device by data transfer. Further, the transmitting module 11 extracts a call signal and a control signal from a transmission signal transmitted from the external apparatus, and supplies the call processing module 12 with the call signal and the control module 13 with the control signal. Further, the transmitting module 11 multiplexes a serial data signal supplied from the call processing module 12 or the control module 13 in time division, and generates and transmits a transmission signal.

The call processing module 12 retrieves call data included in the call signal supplied from the transmission module 11, and plays back an analogue call reception audio signal from the call data. Further, the call processing module 12 drives a receiver of the handset 15 or the headset 16 based on the played-back call reception audio signal, and causes the receiver to output the call reception audio. Further, only an analogue call audio signal generated by the transmitter of the handset 5 or the headset 16 is input to the call processing module 12. The call processing module 12 converts the transmission call audio signal to a call signal of a predetermined format and supplies the transmitting module 11 with the converted call signal.

The control module 13 includes a CPU, a ROM, a RAM, and the like, and controls each module of the telephone main body 1 through software processing. Further, the control module 13 is operated at a power supply voltage of 3.3 [V] supplied from the power source module 20.

The operation panel module 14 includes a display module 141, such as a liquid crystal display (LCD), and a key input module 142. On the display module 141, a telephone directory and a variety of information indicating the operation state of the device output from the control module 13 are also displayed.

On the side of the headset 16, a headset interface circuit 17 is provided between the call processing module 12 and the headset 16. A plurality of kinds, such as two kinds, of headsets are selectively used as the headset 16.

In order to be compliant with two kinds of headsets 16, the headset interface circuit 17 is configured to include two amplifiers AMP1, AMP2, an amplifying circuit 18 formed of a switch SWa designed to switch between the two amplifiers, and a current detection circuit 19. The current detection circuit 19 detects the operation current of the headset 16, outputs a control signal used for switching to the switch SWa according to the operation current, and switches the amplification degree of the transmitter of the headset 16 by switching the amplifiers AMP1, AMP2.

When an electret type and a carbon type are selectively used as the headset 16, the electret type requires smaller bias current and have lower call transmission sensitivity than the carbon type. Accordingly, the current detection circuit 19 performs control so as to detect the operation current of the transmitter of the headset 16 and switches to the amplifier AMP2 with a greater amplification degree and a smaller bias current in the case of the electret type. In the case of the carbon type, control is performed so as to switch to the amplifier AMP1 with a smaller amplification degree and with a greater bias current.

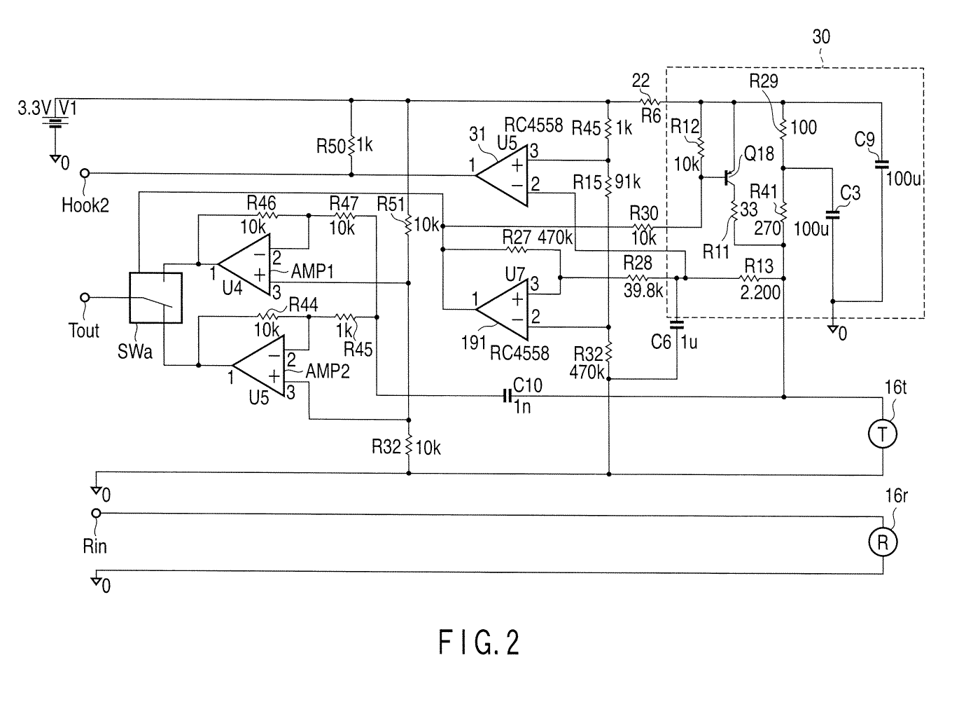

FIG. 2 is a detailed circuit configuration of the headset interface circuit 17.

In FIG. 2, V1 refers to a power resource, HOOK2 refers to an off hook signal output terminal, Tout refers to a transmitter output terminal, and Rin refers to a receiver input terminal.

The current detection circuit 19 includes a comparator 191 configured to detect an operation current and operate at a power supply voltage of equal to or smaller than 3.3 [V]. The reference numeral 31 is a comparator for off hook detection.

The reference numeral 30 indicates a two-stage decoupling circuit 30 configured to prevent noise from being mixed from the power source V1 with respect to the operation current of the transmitter 16t of the headset 16, according to the type of the headset 16. The decoupling circuit 30 forms CR filters of R6 and C9, and R29 and C3. The transistor Q18 switches both the load resistance and the decoupling circuit 30.

Next, this operation will be described in detail.

When connection of the transmitter 16t has been detected, or when a headset including switch is used, an off hook signal (of H level) is output from the comparator 31 to the off hook signal output terminal HOOK2.

since the operation current is small when the transmitter 16t of the headset 16 is the electret type, the transistor Q18 is in an off state, operates with a small bias current of equal to or smaller than 1 [mA], and forms a hysteresis comparator together with the comparator 191 and resistances R27, R28 and R13. An operation current of equal to or smaller than 1 [mA] flows to the transmitter 16t when the electret is connected. Since the hysteresis comparator input is equal to or smaller than 2 [mA], a voltage of approximately 3 [V] is input at 1 [mA] on the A-C line, and the output of the comparator 191 becomes high (H). Thereby, the transistor Q18 is turned off, and the switch SWa is connected to the amplifier AMP2. The call transmission signal from the transmitter 16t is terminated by the load resistance R29, and output to the output terminal Tout via the capacitor C10 and the amplifier AMP2.

Register R46 and R47 refer to resistances defining the gain when carbon is connected. The gain will be R46/R47=10K/10K=1.

In this case, the control signal output from the comparator 191 is supplied to the transistor Q18 of the decoupling circuit 30. Since the voltage supplied to the transistor Q18 is as small as 0.05 [V], the transistor Q18 will be in an off state. In this off state, the decoupling capacitor C9 supplies the condensed current to the load resistance R29, and the decoupling capacitor C3 supplies the condensed current to the load resistance R41. Thereby, the direct current voltage from the power source V1 is stabilized. Thus, noise mixing from the power source V1 with respect to the operation current of the transmitter 16t of the headset 16 is prevented.

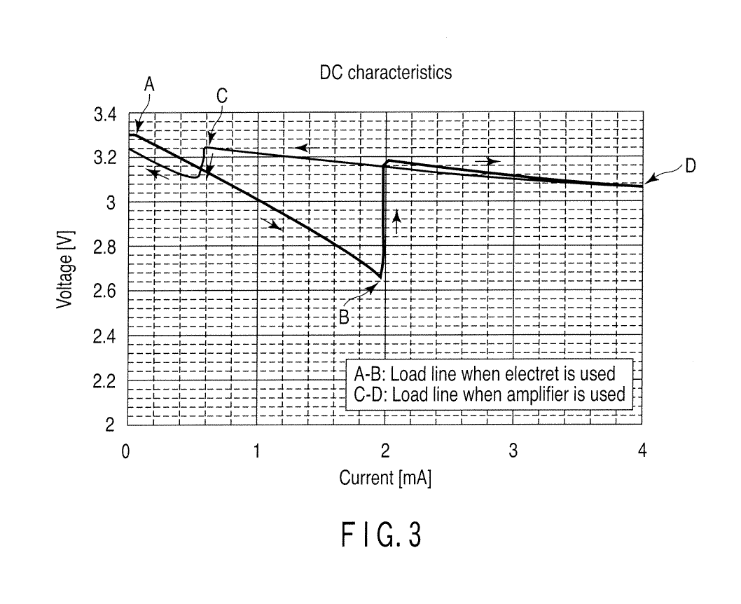

When the transmitter 16t of the headset 16 is a carbon type, on the other hand, an operation current of equal to or greater than 4 [mA] flows to the transmitter 16t. Since the hysteresis comparator input is equal to or greater than 2 [mA] in FIG. 3, a voltage of approximately 3.2 [V] is input at 2 [mA] on the line B-D, and the output of the comparator 191 becomes low (L). Thereby, the transistor Q18 is turned on, and the switch SWa is connected to the amplifier AMP1. The transmission signal from the transmitter 16t is terminated by the signal load resistances R29, R41, R11, and is output to the output terminal Tout via capacitor C10 and the amplifier AMP1.

In this case, the control signal output from the comparator 191 is supplied to the transistor Q18 of the decoupling circuit 30. Since the voltage that is supplied to the transistor Q18 is as great as 0.65 [V], the transistor Q18 is set to an on state. When the transistor Q18 is in an on state, resistances R11, R29, and R41 will be load resistances.

In this on state, the decoupling capacitor C9 supplies the condensed current to the load resistances R29 and R11, and thereby stabilizes the direct current voltage from the power source V1.

As shown in FIG. 3, since the current voltage at which the operation current increases switching is made from the electret type to the carbon type and the current voltage at which the current decreases and switching is made from the carbon type to the electret type differ, the comparator 191 has hysteresis characteristics. Because of the hysteresis characteristics, switching operation is prevented from being performed unnecessarily, and the operation is prevented from becoming unstable.

As described above, according to the first embodiment, since the comparator 191, which operates at a power supply voltage of 3.3 [V] is used to detect the operation current of the transmitter 16t of the headset 16, the headset interface circuit 17 can be operated with the power supply voltage of equal to or lower than 3.3 [V]. Thereby, the power source circuit of the entire telephone 1 can be unified, and the circuit configuration is simplified.

Moreover, according to the first embodiment, noise mixing from the power source V1 is prevented according to the kind of the headset 16 connected thereto, by switching the one-stage decoupling capacitor C9 and the two-stage decoupling capacitors C3, C9, according to the detected operation current of the transmitter 16t of the headset 16.

### Second Embodiment

The second embodiment is configured such that a balance circuit designed to reduce signal noise mixing from the handset is connected to an input terminal of an amplifier having a high amplification degree.

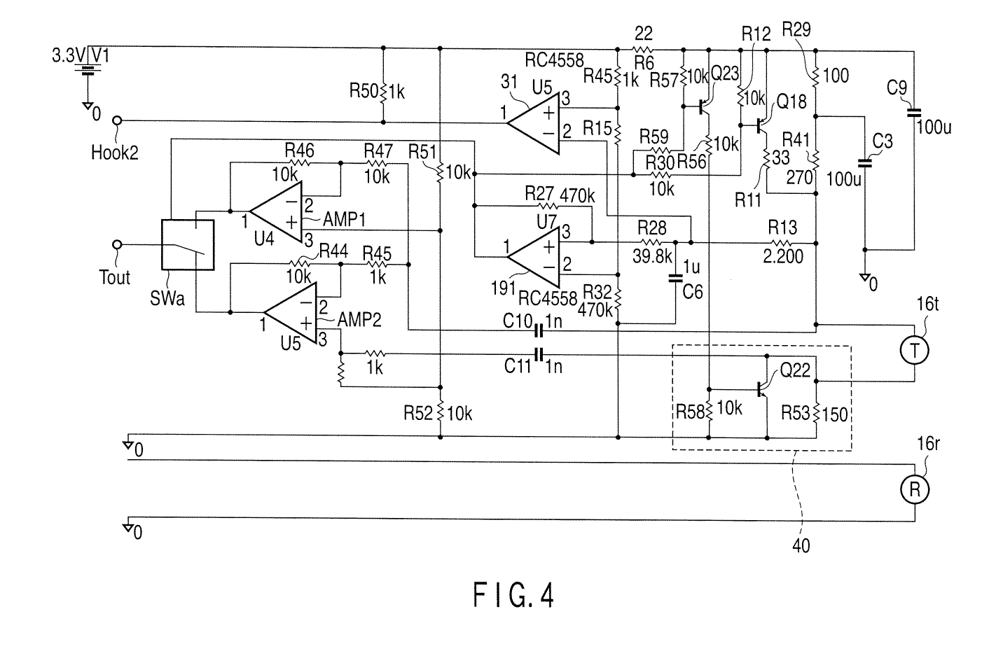

FIG. 4 illustrates a detailed circuit configuration of a headset interface circuit 17 according to the second embodiment. In FIG. 4, the structural elements same as those of FIG. 2 will be referred to by the same reference numerals and detailed description of such elements will be omitted.

A balance circuit 40 is provided at the input terminal of the amplifier AMP2. Further, a transistor Q23 designed to switch the output of the balance circuit 40 between on and off with respect to the amplifier AMP2 is included.

Next, the operation will be described.

When the transmitter 16t of the headset 16 is driven, an off hook signal (of H level) is output to an off hook signal output terminal HOOK2 from a comparator 31.

Since the operation current is small when the transmitter 16t of the headset 16 is an electret type, transistors Q18, Q23 will be in off states, and an operation current of equal to or smaller than 1 [mA] flows to the transmitter 16t when the electret is connected. Since the hysteresis comparator input is equal to or smaller than 2 [mA], a voltage of approximately 3 [V] is input at 1 [mA] on the A-C line of FIG. 3, and the output of the comparator 191 will be high (H). Thereby, the transistor Q18 is turned off, and the switch SWa is connected to the amplifier AMP2. The call transmission signal from the transmitter 16t is terminated by the load resistance R29, and output to the output terminal Tout via the capacitor 10 and the amplifier AMP2.

In this case, the control signal output from the comparator 191 is supplied to the transistors Q18, S23 of the decoupling circuit 30. Since the voltage supplied to the transistors Q18, Q23 is as small as 0.05 [V], the transistors Q18, Q23 will be in off states. In the off state, the transistor Q22 of the balance circuit 40 will also be in an off state, and the output signal from the balance circuit 40 will not be input to the input terminal of the amplifier AMP2.

When the transmitter 16t of the headset 16 is a carbon type, on the other hand, an operation current equal to or greater than 4 [mA] flows. Since the hysteresis comparator input is equal to or greater than 2 [mA], a voltage of approximately 3.2 [V] is input at 2 [mA] on the line B-D of FIG. 3, and the output of the comparator 191 will be low (L). Thereby, the transistor Q18 is turned on, and the switch SWa is connected to the amplifier AMP1. The call transmission signal from the transmitter 16t is terminated by the load resistances R29, R41, R11, and output to the output terminal Tout via the capacitor C10 and the amplifier AMP1.

In this case, the control signal output from the comparator 191 is supplied to the transistors Q18, Q23. Since the voltage supplied to the transistors Q18, Q23 is as high as 0.65 [V], the transistors Q18, Q23 will be in on states. When the transistor Q18 is in an on state, resistances R11, R29, R41 will be the load resistances.

In this on state, the output signal from the transistor Q23 is supplied to the transistor Q22 of the balance circuit 40, and thereby the transistor Q22 is set to an on state. Since the transistor Q22 is in an on state, signal noise mixing from the handset 15 into the output signal of the transmitter 16t is reduced by the balance circuit 40, and the output signal of the transmitter 16t is supplied to the input terminal of the amplifier AMP2.

As described above, according to the second embodiment, by inputting a signal from the balance circuit 40 only to the amplifier AMP2 with a low sensitivity, the signal noise from the handset 15 can be reduced, which is efficient in achieving further lower voltages.

### Third Embodiment

The third embodiment is configured such that a one-stage configuration and a two-stage configuration of decoupling capacitors C3, C9 are manually switched.

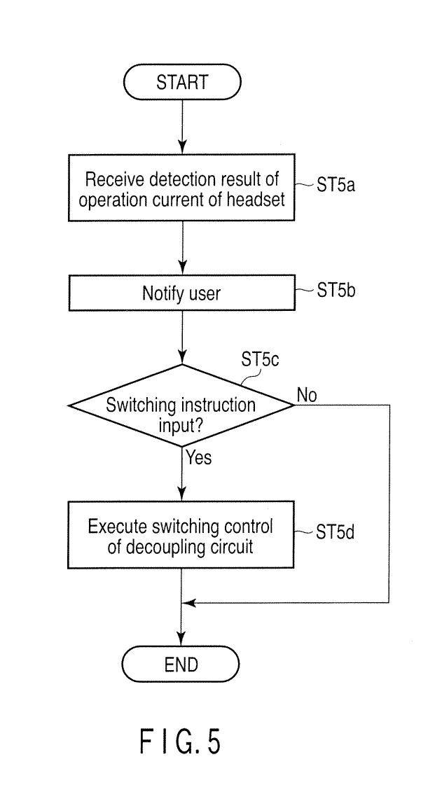

FIG. 5 is a flowchart illustrating the control procedure of a control module 13 configured to switch between the one-stage configuration and the two-stage configuration of the coupling capacitors C3, C9.

Upon receipt of a detection result of a transmitter 16t of a headset 16 by a comparator 191 from a headset interface circuit 17 (block ST5a), a control module 13 judges whether it is a switching time of a decoupling circuit 30, and when it is the switching time, a message indicating that it is the switching time is supplied to and displayed on a display module 141 of an operation panel module 14 in block ST5b.

Assume that the user inputs a switching instruction in a key input module 142 so as to switch between the one-stage configuration and the two-stage configuration of the decoupling capacitors C3, C9 in this state. In that case, the control module 13 shifts the state from block St5c to block ST5d, and shifts the decoupling capacitors C3, 9 from the one-stage configuration to the two-stage configuration, or from the two-stage configuration to the one-stage configuration.

The procedure ends when the user does not input a switching instruction even after a predetermined period of time has elapsed in block ST5c.

Thus, according to the third embodiment, the switching time between the one-stage configuration and the two-stage configuration of the decoupling capacitors C3, C9 is displayed on the display module 141, and the one-stage configuration and the two-stage configuration of the decoupling capacitors C3, C9 are switched after waiting for the instruction by the user. Thereby, even during the switching time between the one-stage configuration and the two-stage configuration of the decoupling capacitors C3, C9, switching will not be performed when switching is not needed at that point in time, which is efficient in achieving lower power consumption of the headset interface circuit.

### Other Embodiments

The embodiment is not limited to the above-described embodiments. For example, the third embodiment may be configured so as to include both a mode in which switching is automatically made at the time of switching of the coupling capacitor and a mode in which switching is made after the user inputs a switching instruction, and selectively operate these modes according to the selection instruction by the user.

Further, the third embodiment may also be applied to the second embodiment. Moreover, both a mode in which a balance circuit input and an unbalance input are automatically switched and a mode in which switching is made after the user inputs a switching instruction may be provided such that these modes are selectively operated according to a selection instruction by the user.

Moreover, a case has been described where both of the decoupling circuit 30 and the balance circuit 40 are included, but the amplifiers AMP1, AMP2 may be switched by the comparator 191 of the current detection circuit 19.

Furthermore, in the first embodiment, a case has been described where the number of stages of the decoupling capacitors is switched, but only one of a plurality of decoupling capacitors may be switched.

Various other modifications may be made within the scope of the embodiment, with respect to electronic devices other than the telephone, circuit components of the headset interface circuit, or the like.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A headset interface circuit, comprising:
a connector configured to selectively connect a plurality of headsets to a communication apparatus configured to operate at a predetermined power supply voltage and designed to provide telephone calls via a handset, wherein the plurality of headsets being different types from one another;
a plurality of amplifiers configured to selectively amplify an output signal from a transmitter of the headset and supply the communications apparatus with the amplified output signal, wherein the plurality of amplifiers including different amplification degrees;
a detector configured to cause a comparator to detect an operation current of the transmitter of the headset, wherein the comparator operating at a voltage of equal to or smaller than the power supply voltage; and
an amplification switch configured to switch the amplifier based on a detection result by the detector.

2. The headset interface circuit of claim 1, comprising:
a plurality of decoupling capacitors configured to prevent noise mixing from a power source in the operation current of the transmitter in compliant with the plurality of headsets; and
a plurality of decoupling switches configured to switch between the plurality of decoupling capacitors based on the detection result by the detector.

3. The headset interface circuit of claim 2, wherein the decoupling switch comprises:
a first mode of automatically switching the plurality of decoupling capacitors based on the detection result by the detector;
a second mode of notifying a user of the detection result by the detector and switching between the plurality of decoupling capacitors when the user has input a switching instruction in response to the notification; and
a mode selecting controller configured to selectively execute the first and second modes based on a mode specification instruction by a user.

4. The headset interface circuit of claim 1, further comprising:
a balance circuit connected to an input terminal of an amplifier including the highest amplification degree, and configured to reduce signal noise mixing from the handset in the operation current of the transmitter of the headset; and
a balance switch configured to switch between connection and release between an input terminal of the amplifier and the balance circuit.

5. The headset interface circuit of claim 4, wherein the balance switch includes:
a first mode of automatically switching between connection and release between an input terminal of the amplifier and the balance circuit;
a second mode of notifying a user of a detection result by the detector and switching between connection and release between the input terminal of the amplifier and the balance circuit when a user has input a switching instruction in response to the notification;
a mode selecting controller configured to selectively execute the first and second modes based on a mode specification operation by the user.

6. A telephone set, comprising:
a connector configured to selectively connect a plurality of headsets, wherein the plurality of headsets being different types from one another;
a plurality of amplifiers configured to selectively amplify an output signal from a transmitter of the headset, wherein the plurality of amplifiers including different amplification degrees;
a detector configured to cause a comparator to detect an operation current of the transmitter of the headset, wherein the comparator operating at a voltage of equal to or smaller than a power supply voltage of the telephone set; and
an amplification switch configured to switch the amplifier based on a detection result by the detector.

7. The telephone set of claim 6, comprising:
a plurality of decoupling capacitors configured to prevent noise mixing from a power source in the operation current of the transmitter in compliant with the plurality of headsets; and
a plurality of decoupling switches configured to switch between the plurality of decoupling capacitors based on the detection result by the detector.

8. The telephone set of claim 7, wherein the decoupling switch comprises:
a first mode of automatically switching the plurality of decoupling capacitors based on the detection result by the detector;
a second mode of notifying a user of the detection result by the detector and switching between the plurality of decoupling capacitors when the user has input a switching instruction in response to the notification; and
a mode selecting controller configured to selectively execute the first and second modes based on a mode specification instruction by a user.

9. The telephone set of claim 6, further comprising:
a balance circuit connected to an input terminal of an amplifier including the highest amplification degree, and configured to reduce signal noise mixing from the handset in the operation current of the transmitter of the headset; and
a balance switch configured to switch between connection and release between an input terminal of the amplifier and the balance circuit.

10. The telephone set of claim 9, wherein the balance switch includes:
a first mode of automatically switching between connection and release between an input terminal of the amplifier and the balance circuit;
a second mode of notifying a user of a detection result by the detector and switching between connection and release between the input terminal of the amplifier and the balance circuit when a user has input a switching instruction in response to the notification;
a mode selecting controller configured to selectively execute the first and second modes based on a mode specification operation by the user.
